(19) United States
(12) Patent Application Publication
(10) Pub. No.: US 2026/0321282 A1
(43) Pub. Date: Oct. 15, 2026

(54) SUSPENSION FOR HARD DISK DRIVE

(71) Applicant: NHK SPRING CO., LTD., Yokohama-shi (JP)

(72) Inventor: Masaki YOKOTA, Yokohama-shi (JP)

(73) Assignee: NHK SPRING CO., LTD., Yokohama-shi (JP)

(21) Appl. No.: 19/467,484

(22) Filed: Feb. 2, 2026

(30) Foreign Application Priority Data
Feb. 6, 2025 (JP) 2025-018249

(51) Int. Cl. G11B 5/48

(52) U.S. Cl. CPC G11B 5/4833; G11B 5/4826

(57) ABSTRACT

According to one embodiment, a suspension for a hard disk drive, includes a load beam having a first surface, a flexure having a second surface facing the first surface, and at least one fixation portion where the load beam and the flexure are fixed. The at least one fixation portion has a first protruding portion in which one of the first surface and the second surface protrudes toward the other, and the first surface and the second surface come into contact, and a gap portion defined around the first protruding portion between the first surface and the second surface, in which the first surface and the second surface are separated.

### CROSS-REFERENCE TO RELATED APPLICATIONS

This application is based upon and claims the benefit of priority from prior Japanese Patent Application No. 2025-018249, filed Feb. 6, 2025, the entire contents of which are incorporated herein by reference.

### BACKGROUND OF THE INVENTION

### 1. Field of the Invention

The present invention relates to a suspension for a hard disk drive.

### 2. Description of the Related Art

For information processing devices such as personal computers, hard disk drives (HDD) are used. A hard disk drive includes a magnetic disk which rotates around a spindle, a carriage which pivots about a pivotal axis and the like. The carriage has an arm, and is pivoted about the pivotal axis by a positioning motor such as a voice coil motor in a track width direction of the disk.

To the above-mentioned arm, a hard disk drive suspension (hereinafter, referred to simply as a suspension) is attached. The suspension includes a base plate, a load beam, a flexure provided along the load beam, and the like. A slider, which constitutes the magnetic head, is mounted on a gimbal portion formed near the distal end of the flexure.

The slider is provided with elements (transducers) for performing access operations such as reading or writing data. The load beam, flexure, and slider constitute a head gimbal assembly.

To accommodate higher recording densities on disks, it is necessary to further miniaturize the head gimbal assembly and enable higher precision positioning of the slider relative to the recording surface of the disk. Under such circumstances, various proposals have been made for hard disk drive suspensions (for example, JP 4377775 B, JP 4367712 B, US 7,430,096 B).

However, even considering the proposals in the above-listed patent documents, there remains considerable room for improvement regarding the stabilization of the joint state between the load beam and the flexure.

### BRIEF SUMMARY OF THE INVENTION

One of objects of the present invention is to provide a suspension for hard disk drives which can improve reliability.

According to one embodiment, a suspension for a hard disk drive comprises a load beam having a first surface, a flexure having a second surface facing the first surface, and at least one fixation portion where the load beam and the flexure are fixed. The at least one fixation portion includes a first protruding portion where one of the first surface and the second surface protrudes toward the other surface, and the first surface and the second surface come into contact, and a gap portion defined around the first protruding portion between the first surface and the second surface, where the first surface and the second surface are separated.

The flexure may further include a mounting portion on which the slider is mounted. The load beam may further include a second protruding portion which overlaps with the mounting portion and projects toward the flexure. The at least one fixation portion may be provided on a distal end side relative to the mounting portion. The height of the first protruding portion may be less than the height of the second protruding portion.

The flexure may further include a mounting portion on which the slider is mounted, and a pair of arms provided on respective sides of the mounting portion. The load beam may further include a second protruding portion which overlaps the mounting portion and projects toward the flexure. The pair of arms may respectively include a first end portion located on a distal end side relative to the mounting portion and a second end portion on an opposite side to the first end portion in the longitudinal direction of the flexure. The at least one fixation portion may be provided at the second end portion. The height of the first protruding portion may be less than the height of the second protruding portion.

The at least one fixation portion may further include a welded portion where the load beam and the flexure are welded together. The size of the first protruding portion in plan view may be greater than the size of the welded portion in plan view. The first protruding portion may be located in the area where the load beam and the flexure overlap each other. The first protruding portion may have a circular shape in plan view.

The first protruding portion may protrude from the first surface toward the second surface. The height of the first protruding portion may be less than the thickness of the load beam. The load beam may further include a third surface on an opposite side to the first surface. The at least one fixation portion may further include a recessed portion that overlaps the first protruding portion and is recessed from the third surface toward the first surface.

The first protruding portion may protrude from the second surface toward the first surface. The height of the first protruding portion may be less than the thickness of the flexure. The flexure may further have a fourth surface on an opposite side to the second surface. The at least one fixation portion may further have a recess portion that overlaps the first protruding portion and is recessed from the fourth surface toward the second surface.

According to the above configuration, a suspension for a hard disk drive which can improve the reliability can be provided.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a schematic perspective view showing an example of a hard disk drive.

FIG. 2 is a cross-sectional view showing an example of the hard disk drive.

FIG. 3 is a schematic plan view of a suspension according to the first embodiment.

FIG. 4 is a schematic plan view showing a load beam shown in FIG. 3.

FIG. 5 is a schematic side view of the load beam shown in FIG. 3.

FIG. 6 is a schematic cross-sectional view showing a configuration of an example of a fixation portion in the first embodiment.

FIG. 7 is a partial enlarged view showing a configuration of an example of the fixation portion in the first embodiment.

FIG. 8 is a partial enlarged view showing a configuration of an example of the fixation portion in the first embodiment.

FIG. 9 is a schematic partial cross-sectional view of a suspension according to a comparative example.

FIG. 10 is a schematic partial cross-sectional view of the suspension according to the comparative example.

FIG. 11 is a diagram showing the relationship between frequency and gain when the suspension according to the comparative example is vibrated.

FIG. 12 is a diagram showing the relationship between frequency and gain when the suspension of the first embodiment is vibrated.

FIG. 13 is a schematic cross-sectional view showing an example of a configuration of a fixation portion of a suspension according to the second embodiment.

### DETAILED DESCRIPTION OF THE INVENTION

Various embodiments of the present invention will now be described with reference to the accompanying drawings. For clarity in explanation, the drawings may schematically represent the sizes, shapes, etc., of various parts, differing from those of the actual implementation.

### First Embodiment

FIG. 1 is a schematic perspective view showing an example of a hard disk drive 1 (HDD). In the example of FIG. 1, the hard disk drive 1 comprises a case 2, a plurality of magnetic disks (hereinafter simply referred to as disks 4) which rotate around a spindle 3, a carriage 6 which can pivot around a pivotal axis 5, and a positioning motor (voice coil motor) 7 for driving the carriage 6. The case 2 is airtightly sealed by a cover (not shown).

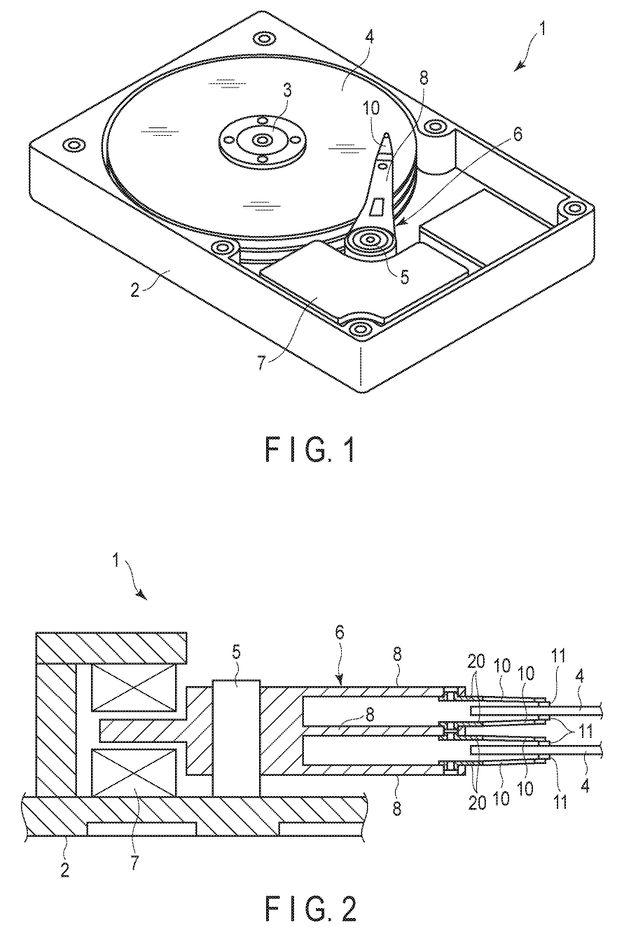

FIG. 2 is a schematic cross-sectional view showing a portion of the hard disk drive 1. As shown in FIG. 2, the carriage 6 is provided with a plurality of (for example, three) arms 8. The number of arms 8 provided on the carriage 6 is not limited to that of the above-mentioned example.

To the distal end portion of each of the arms 8, a hard disk drive suspension (hereinafter referred to as suspension 10) is attached. Further, a slider 11, which constitutes a magnetic head, is provided at the distal end portion of each of the suspensions 10.

When a disk 4 rotates at high speed, air flows in between the disk 4 and the slider 11, thus forming an air bearing. When the carriage 6 is pivoted by the positioning motor 7, the suspension 10 moves in a radial direction of the disk 4, and thereby the slider 11 is moved to a desired track on the disk 4.

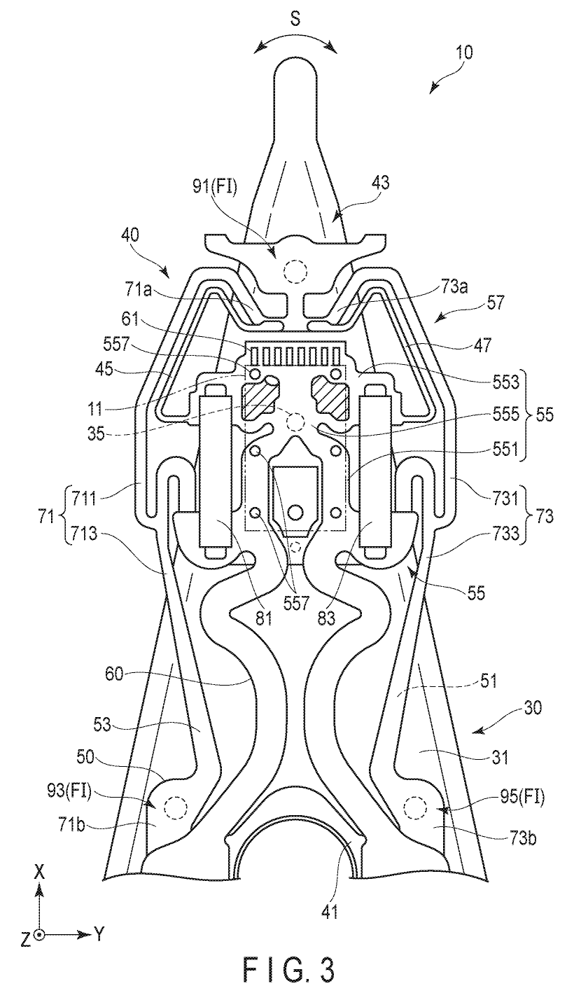

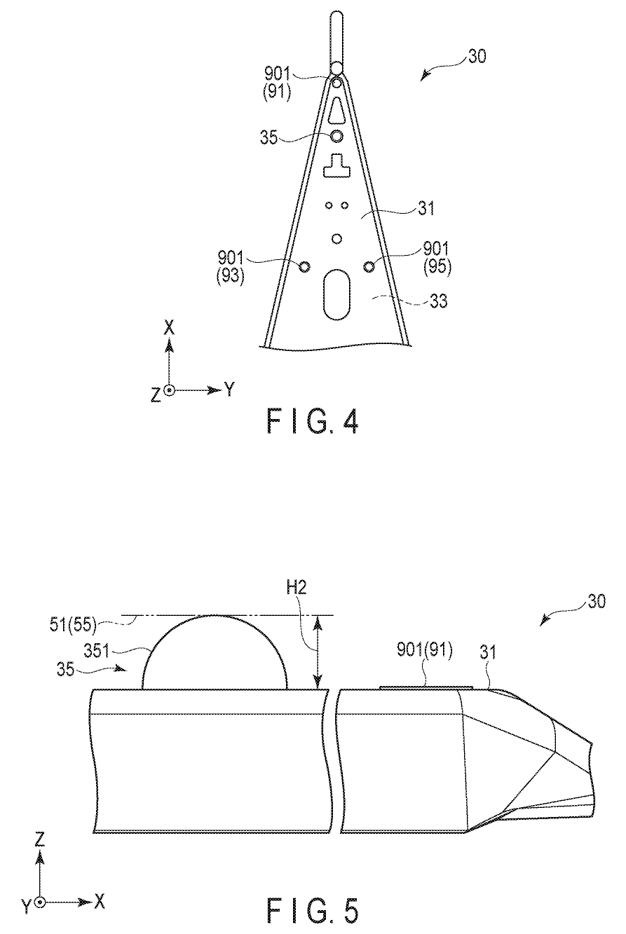

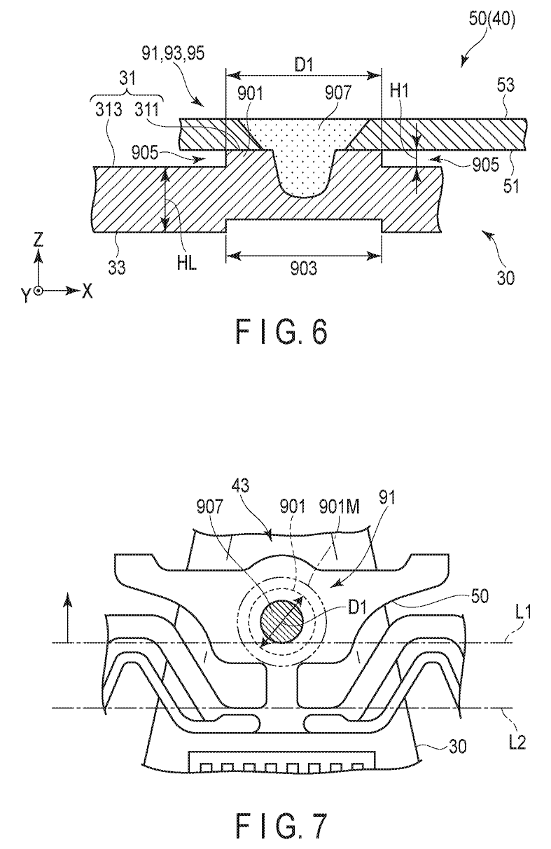

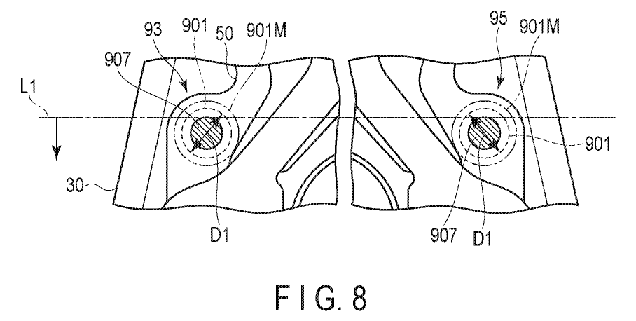

FIG. 3 is a schematic plan view of the suspension 10 according to this embodiment. FIG. 4 is a schematic plan view of the load beam 30 shown in FIG. 3. FIG. 5 is a schematic side view of the load beam 30 shown in FIG. 3. FIG. 6 is a schematic cross-sectional view showing an example of a configuration of the fixation portion FI in this embodiment. FIGS. 7 and 8 are each a partial enlarged view showing an example of a configuration of the fixation portion FI in this embodiment. FIG. 3 shows a portion of the suspension 10, and FIGS. 4 and 5 each show a portion of the load beam 30.

The suspension 10 comprises a load beam 30 and a flexure 40. From FIG. 3 on, the figures may include an X axis, a Y axis, and a Z axis orthogonal to each other. The direction along the X axis is defined as the first direction X, the direction along the Y axis is defined as the second direction Y, and the direction along the Z axis is defined as the third direction Z. Viewing each element parallel to the third direction Z is sometimes referred to as a plan view.

The first direction X corresponds to the longitudinal direction of the suspension 10, load beam 30, and flexure 40. In the first direction X, the side where the slider 11 constituting the magnetic head is mounted with respect to the arm 8 (shown in FIG. 2) may as well be in some cases referred to as the distal end or distal end portion side.

Further, the second direction Y corresponds to the width direction of the suspension 10, load beam 30, and flexure 40, whereas the third direction Z corresponds to the thickness direction of the suspension 10, load beam 30, and flexure 40. Hereinafter, the length along the third direction Z may as well be in some cases be referred to as the thickness or height.

The load beam 30 is formed from a metal material such as stainless steel. The thickness of the load beam 30 is, for example, 30 to 80 μm. As shown in FIG. 4, the load beam 30 has a tapered shape toward the distal end portion. The load beam 30 has a surface 31 and a surface 33. The surface 33 is located on the opposite side to the surface 31. The surface 31 faces the third direction Z, whereas the surface 33 faces the direction opposite to the third direction Z.

The flexure 40 is disposed along the base plate 20 (shown in FIG. 2) and the load beam 30. As shown in FIG. 3, the flexure 40 overlaps with the surface 31 of the load beam 30. The flexure 40 comprises a metal base 50 and a wiring portion 60 overlaid on the metal base 50.

The metal base 50 is formed, for example, from a thin stainless steel plate. The thickness of the metal base 50 is less than the thickness of the load beam 30. The thickness of the metal base 50 is, for example, 15 to 20 μm.

The metal base 50 has a surface 51 and a surface 53. The surface 51 faces the surface 31. The surface 53 is located on the opposite side to the surface 51. The surface 53 corresponds to the surface on which the wiring portion 60 is disposed.

The wiring portion 60 includes a base insulating layer, a conductor layer overlaid on the base insulating layer, and a cover insulating layer overlaid on the conductor layer. The conductor layer includes, for example, wiring lines for reading and wiring lines for writing. These wiring lines are covered by the cover insulating layer.

The metal base 50 further has a tongue portion 55 and a frame portion 57 near the distal end portion of the suspension 10. Both the tongue portion 55 and the frame portion 57 are parts of the metal base 50, and their respective outlines are formed, for example, by etching. The center of the tongue portion 55 along the second direction Y roughly coincides with the center of the load beam 30 along the second direction Y.

The tongue portion 55 includes a first tongue 551, a second tongue 553, and a hinge portion 555. The hinge portion 555 is formed between the first tongue 551 and the second tongue 553. The frame portion 57 is disposed to surround the tongue portion 55. The frame portion 57 includes arms 71 and 73. These arms 71 and 73 are located on respective sides of the tongue portion 55 along the second direction Y.

The arms 71 and 73 respectively include first end portions 71a and 73a and second end portions 71b and 73b on an opposite to the first end portion 71a and 73a along the first direction X. The first end portions 71a and 73a are located on the distal end side with respect to the tongue portion 55. The second end portions 71b and 73b correspond to the proximal end portions of the arms 71 and 73.

The arms 71 and 73 respectively include first portions 711 and 731 and second portions 713 and 733. The first portions 711 and 731 are respectively formed continuously with the second portions 713 and 733. The first portions 711 and 731 respectively include the first end portions 71a and 73a, and the second portions 713 and 733 respectively include the second end portions 71b and 73b.

The arms 71 and 73 are connected to the flexure main body 41 at the second end portions 71b and 73b, respectively. The arms 71 and 73 are connected at the first end portions 71a and 73a by the distal end portion 43 of the flexure.

The first tongue 551 is elastically supported by the arms 71 and 73 to the flexible main body 41 and the flexure distal end portion 43. The second tongue 553 is connected to the first tongue 551 via the hinge portion 555. The width of the hinge portion 555 is sufficiently less than the widths of the first tongue 551 and the second tongue 553. The second tongue 553 is pivotable relative to the first tongue 551 in a sway direction S (shown in FIG. 3).

The second tongue 553 is supported on the flexure distal end portion 43 via limiter members 45 and 47. The limiter members 45 and 47 have the function to suppress excessive sway of the tongue portion 55 or the occurrence of dimple separation when the suspension 10 receives an external impact, for example.

The load beam 30 further has a protruding portion 35 protruding toward the flexure 40 (tongue portion 55). As shown in FIG. 3, the protruding portion 35 overlaps the tongue portion 55. As shown in FIG. 5, the protruding portion 35 has a dome shape.

The surface 351 of the protruding portion 35 is in contact with the surface 51 of the tongue portion 55, as shown in FIG. 5. In FIG. 5, the surface 51 is indicated by a two-point dashed line. In the case where the surface 351 is in contact with the tongue portion 55 (surface 51), the tongue portion 55 is formed to be able to perform desired gimbal motion centered on the protruding portion 35. The tongue portion 55, the arms 71 and 73, and the protruding portion 35 constitute the gimbal portion.

On a part of the tongue portion 55, the slider 11, which constitutes the magnetic head, is mounted as shown in FIG. 3. The tongue portion 55 includes the portion overlapping the slider 11 and its surrounding portion. In FIG. 3, the slider 11 is indicated by a two-point dashed line. On the distal end portion of the slider 11, an element which can detect magnetic signals as changes in electrical resistance, such as an MR element, and the like are provided.

The wiring portion 60 is electrically connected to the elements on the slider 11 via the terminal portion 61 for the slider 11. The terminal portion 61 is electrically conductive with the conductor layer of the wiring portion 60. These elements perform access operations such as writing or reading data to/from the disk 4 (shown in FIG. 2). The head gimbal assembly is configured by the slider 11, the load beam 30, the flexure 40 and the like.

On the flexure 40, actuators 81 and 83 are further mounted. The actuators 81 and 83 have primarily function to pivot the second tongue 553 in the sway direction. The actuators 81 and 83 are, for example, piezoelectric elements formed of a material such as lead zirconate titanate (PZT).

The actuators 81 and 83 are disposed on the respective sides of the slider 11 along the second direction Y. The end portions of the actuators 81 and 83 along the first direction X are fixed to the first tongue 551 and the second tongue 553, respectively, with an adhesive or the like.

As shown in FIG. 3, on the surface 53 of the tongue portion 55 (first tongue 551 and second tongue 553) of the metal base 50, pillow pads 557 are disposed. The pillow pads 557 are disposed on the first tongue 551 and the second tongue 553, respectively.

These pillow pads 557 are made of a resin such as polyimide and each form a projection shape extending from the surface 53 toward the slider 11. The slider 11 is supported at a predetermined position on the tongue portion 55 by these pillow pads 557.

Next, the fixation portion in this embodiment will be described.

The suspension 10 further comprises at least one fixation portion FI. The load beam 30 and flexure 40 are fixed at the fixation portion FI. The suspension 10 may include, for example, a plurality of fixation portions FI. In the example of FIG. 3, the fixation portion FI includes fixation portions 91, 93, and 95. Note that there may be only one fixation portion FI, or may be two, or four or more.

As shown in FIG. 3, the fixation portion 91 is provided on a distal end side with respect to the tongue portion 55 along the first direction X. Specifically, the fixation portion 91 is provided on flexure distal end portion 43. Further, the fixation portions 93 and 95 are provided on the second end portions 71b and 73b of the arms 71 and 73, respectively.

As shown in FIG. 6, the fixation portions 91, 93, and 95 each have a protruding portion 901 and a recess portion 903. The protruding portion 901 is formed in such a manner that one of the surface 31 of the load beam 30 and the surface 51 of the metal base 50 protrudes toward the other. Further, the surface 31 and the surface 51 are in contact with each other at the protruding portion 901.

In this embodiment, as shown in FIG. 6, the load beam 30 has a protruding portion 901 and a recessed portion 903. The protruding portion 901 protrudes from the surface 31 of the load beam 30 toward the surface 51.

The surface 31 includes a surface 311 where the protruding portion 901 is formed and a surface 313 where the protruding portion 901 is not formed. The surface 311 is substantially parallel to, for example, the surface 313. From another perspective, the surface 311 is substantially parallel to the surface 51. The recessed portion 903 is indented from the surface 33 toward the surface 31. The recessed portion 903 overlaps with the protruding portion 901 along the third direction Z.

The fixation portions 91, 93, and 95 each further have a gap portion 905 between the surface 31 and the surface 51. The gap portion 905 is defined around the protruding portion 901. Here, the expression “around the protruding portion 901” may refer to the entire circumference of the protruding portion 901 or a part of the surrounding of the protruding portion 901.

In the gap portion 905, the surface 31 (surface 313) and the surface 51 are separated from each other. In other words, in the gap portion 905, the surface 31 and surface 51 are not in contact with each other. The distance between the surface 31 and surface 51 in the gap portion 905 can be adjusted by the height of the protruding portion 901.

The height H1 of the protruding portion 901 is less than the thickness HL of the load beam 30. The height H1 of the protruding portion 901 in this embodiment is, for example, the distance between the surface 311 and the surface 313 along the third direction. When focusing on the relationship with the protruding portion 35, the height H1 of the protruding portion 901 is less than the height H2 of the protruding portion 35, as shown in FIG. 5. With this configuration, it is possible to ensure contact pressure between the protruding portion 35 and the tongue portion 55 of the flexure 40.

The height H1 of the protruding portion 901 should preferably be 1/10 or more of the thickness of the load beam 30, for example. With this configuration, it is possible to precisely creates a step in the surface 313 of the load beam 30, and reliably form the gap portion 905. The height H1 of the protruding portion 901 is, for example, 3 μm to 30 μm. On the other hand, the height H2 of the protruding portion 35 is, for example, 50 μm to 90 μm.

In the example of FIG. 4, the protruding portion 901 has a circular shape in plan view. The term “circular shape” covers not only a true circular shape but also elliptical shapes, oblong shapes, and shapes where a portion of these circular shapes is missing. Further, the planar shape of the protruding portion 901 is not limited to a circular shape, but it may as well be polygonal or any other shape besides those mentioned above. The recessed portion 903 has a planar shape similar to that of the protruding portion 901, for example.

The fixation portions 91, 93, and 95 further include a welded portion 907 where the load beam 30 and the metal base 50 are welded together. The welded portion 907 is formed, for example, by laser welding. The laser is irradiated, for example, from the surface 53 side of the flexure 40.

The load beam 30 and the metal base 50 are fixed to each other by the welded portion 907. The welded portion 907 is formed by melting portions of the materials which form the load beam 30 and the metal base 50, respectively. In FIGS. 7 and 8, the welded portion 907 is indicated by a hatched pattern.

The flexure 40 is fixed to the load beam 30 such that desired gimbal motion can be performed around the protruding portion 35 between the welded portion 907 of the fixation portion 91 and the welded portion 907 of the fixation portions 93 and 95 (between lines L1 shown in FIGS. 7 and 8).

The line L1 shown in FIG. 7 indicates the edge (lower edge) of the welded portion 907 of the fixation portion 91 along the first direction X. The line L1 shown in FIG. 8 indicates the edge (upper and lower edges) of the welded portions 907 of the fixation portions 93 and 95 along the first direction X. Note that the area from above the line L1 indicated by the arrow in FIG. 7 and the area from below the line L1 indicated by the arrow in FIG. 8 have a little effect, if any, on the desired gimbal motion.

The welded portion 907 has a circular shape in plan view. When focusing on its relationship with the protruding portion 901, the welded portion 907 is formed concentrically with the protruding portion 901, for example. Further, the welded portion 907 has a diameter which gradually decreases in a direction opposite to the third direction Z.

The size D1 of the protruding portion 901 in plan view, as shown in FIGS. 7 and 8, is greater than the size of the welded portion 907 in plan view. When the protruding portion 901 is of a circular shape, the size D1 corresponds to the diameter of the protruding portion 901. The size D1 of the protruding portion 901 in plan view should preferably be, for example, two to three times the size of the welded portion 907 in plan view.

When focusing on the relationship between the protruding portion 901 and the flexure 40, the protruding portion 901 is located within the area where the load beam 30 and the metal base 50 of the flexure 40 overlap each other. In other words, in plan view, the protruding portion 901 is not substantially exposed from the metal base 50. But, in plan view, the protruding portion 901 may be partially exposed from the metal base 50.

By forming the protruding portion 901 to have such dimensions, it is possible to form the gap portion 905 appropriately around the welded portion 907. In FIGS. 7 and 8, the maximum size of the protruding portion 901 in plan view is indicated by a two-point dashed line as a protruding portion 901M.

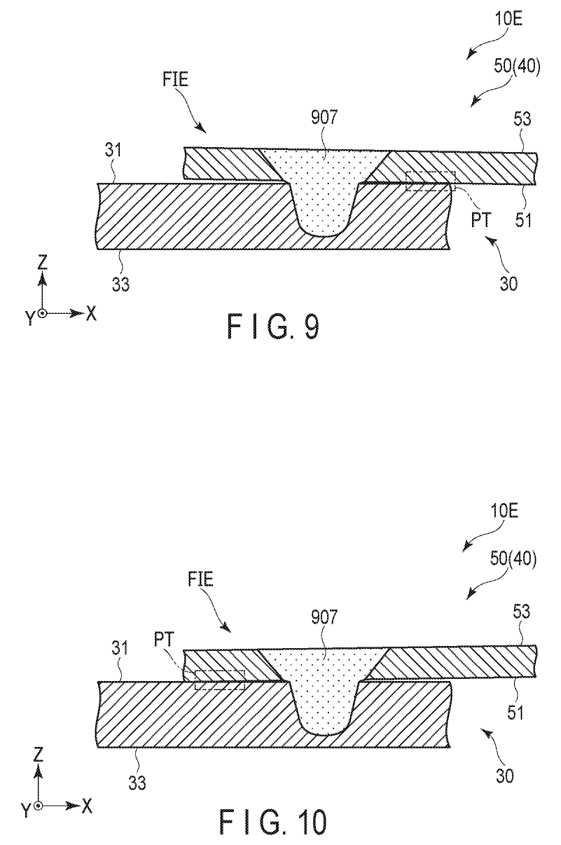

FIGS. 9 and 10 are schematic partial cross-sectional views each showing a suspension 10E according to a comparative example. In the suspension 10E according to the comparative example, a fixation portion FIE does not have an element corresponding to that of the protruding portion 901 of the present embodiment.

In the suspension 10E of the comparative example, the bonding state between the load beam 30 and the flexure 40 tends to vary from one product to another. Specifically, as shown in FIGS. 9 and 10, in the fixation portion FIE, portions where the load beam 30 and the metal base 50 are separated from or in contact with each other are formed near the welded portion 907.

In other words, the locations where these portions are formed around the welded section 907 vary from one product to another. That is, in the suspension 10E, the contact state (restraint state) between the load beam 30 and the metal base 50 around the welded section 907 vary from one product to another.

FIGS. 9 and 10 show the portions where the load beam 30 and the metal base 50 are in contact with each other as portions PT. Such variation in the contact state can become a factor which causes resonance characteristics to vary from one product to another.

The load beam 30 is subjected to more complex processing compared to the metal base 50. Here, it is more difficult to form the distal end portion end of the load beam 30 to be flat than that of the metal base 50. Consequently, the contact state between the load beam 30 and the metal base 50 is particularly prone to variation at the distal end portion end of the suspension 10E.

Further, the contact state at the distal end portion end of the suspension 10E readily affect the resonance characteristics. Here, the distal end side refers to the further end side from the line L2 shown in FIG. 7 (the upper part in the figure). The line L2 indicates the upper end of the position where the first end portions 71a and 73a of the respective arms 71 and 73 are connected to the flexure distal end portion 43.

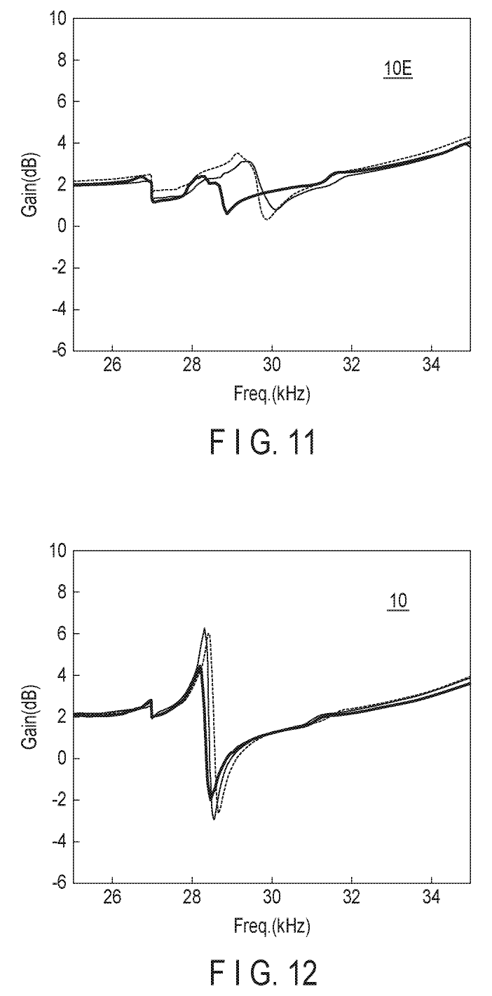

FIG. 11 is a diagram showing the relationship between frequency and gain when the suspension 10E of the comparative example is vibrated. In FIG. 11, the horizontal axis represents frequency (Freq. (kHz)), and the vertical axis represents gain (Gain (dB)). Further, FIG. 11 shows the resonance characteristics of the three suspensions 10E.

In the example shown in FIG. 11, for instance, significantly different resonance characteristics appear for each product around 27to 31 kHz. As shown in FIGS. 9 and 10, the resonance characteristics tend to vary from one product to another due to differences in the position of the formed portion PT near the welded section 907 or due to the state where the portion PT is not formed.

In this embodiment, the fixation portion FI (fixation portions 91, 93, 95) includes a protruding portion 901 and a gap portion 905. The protruding portion 901 is formed in such a manner that one of the surface 31 of the load beam 30 and the surface 51 of the metal base 50 projects toward the other. With this configuration, the gap portion 905 which separates the surface 31 and surface 51 from each other can be formed around the protruding portion 901.

With the configuration that the fixation portion FI has the gap portion 905 around the protruding portion 901, the metal base 50 is brought into contact with the load beam 30 at the protruding portion 901, but it is possible to suppress undesired contact between the metal base 50 and the load beam 30 near the protruding portion 901 which includes the welded portion 907. In other words, the contact state between the load beam 30 and the metal base 50 is uniform at the fixation portion FI. Therefore, the bonding state between the load beam 30 and the flexure-shackle 40 is stabilized.

FIG. 12 is a diagram showing the relationship between frequency and gain when the suspension 10 according to this embodiment is vibrated. In FIG. 12, the horizontal axis represents frequency (Freq. (kHz)), and the vertical axis represents gain (Gain (dB)). Further, FIG. 12 shows the resonance characteristics of three suspensions 10.

In the example shown in FIG. 12, the variation in resonance characteristics between products, as seen with the suspension 10E of the comparative example, is not observed around 27 to 31 kHz. That is, by forming the gap portion 905 by the protruding portion 901 at the fixation portion FI, undesired contact between the metal base 50 and the load beam 30 around the protruding portion 901 can be avoided.

With the above-described configuration, the bonding state between the load beam 30 and the flexure 40 is stabilized, thereby making it possible to suppress variation in the resonance characteristics of the suspension 10 between products. That is, in the suspension 10, the resonance characteristics are stabilized and desirable resonance characteristics can be obtained.

In hard disk drives, there is a demand to increase the storage capacity of the hard disk drive in response to the improvement in recording density. Consequently, the number of magnetic disks equipped in the hard disk drive is being increased (so-called multi-platter configuration), and therefore the thinning of the suspension is necessary.

In thinning the suspension, it is critical to stabilize its resonance characteristics of the suspension. The suspension 10 of this embodiment suppresses variation in resonance characteristics between products, thereby improving the reliability of suspension 10.

In this embodiment, the fixation portion 91 is disposed at the flexure distal end portion 43. With this configuration, it possible to stabilize the contact state between the load beam 30 and the metal base 50 at the distal end portion of the suspension 10, which is susceptible to affecting resonance characteristics. Consequently, variation in the resonance characteristics of the suspension 10 can be further suppressed.

Further, in this embodiment, undesirable contact between the load beam 30 and the metal base 50 can be avoided, and therefore the generation of particles due to contact between the load beam 30 and the metal base 50 can be suppressed.

Furthermore, the contact state between the load beam 30 and the metal base 50 is stabilized, and therefore the vibration modes of the load beam 30 and the flexure 40 can be easily separated. With this configuration, vibration control in the suspension 10 can be facilitated.

Moreover, as in this embodiment, by forming a gap portion 905 in the fixation portion FI in advance, it is possible to ensure clearance between the load beam 30 and the metal base 50. With this configuration, it is possible to enhances the degree of freedom in designing for the cross-sectional shape of the suspension 10, including the load beam 30 and the flexure 40.

Further, in this embodiment, the fixation portions 93 and 95 are disposed at the second end portions 71b and 73b of the respective arms 71 and 73. That is, the fixation portions FI are formed at the respective positions where the load beam 30 and flexure 40 are fixed.

With this configuration, it is possible to stabilize the contact state between the load beam 30 and the metal base 50 not only at the flexure distal end portion 43 but also at the flexure main body 41. Therefore, it becomes easier to achieve the desired gimbal motion between the fixation portion 91 and the fixation portions 93 and 95.

Further, in this embodiment, the protruding portion 901 has a circular shape in plan view. With this configuration, it is possible to facilitate uniform contact between the load beam 30 and the metal base 50 in the X-Y plane defined by the first direction X and the second direction Y.

Furthermore, in this embodiment, the size of the protruding portion 901 in plan view is greater than the size of the welded portion 907 in plan view. With this configuration, it is possible to reliably form the portion where the load beam 30 and the metal base 50 are in contact with each other and the gap portion 905 around the welded portion 907. As a result, the contact state between the load beam 30 and the metal base 50 can be easily stabilized around the welded portion 907.

The suspension 10 configured as described above can improve its reliability. Further, various other advantageous effects can be obtained from this embodiment.

Next, other embodiments will be described. Note that in the other embodiments described below, components similar to those in the first embodiment described above may be designated by the same reference numerals as those of the first embodiment, and their detailed descriptions may be omitted or simplified.

### Second Embodiment

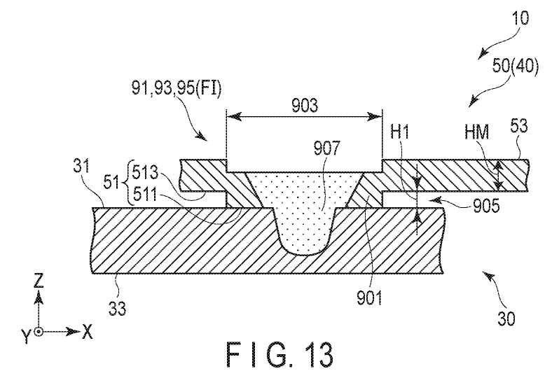

FIG. 13 is a schematic cross-sectional view showing an example of a configuration of a fixation portion FI of a suspension according to this embodiment. In this embodiment, as shown in FIG. 13, the metal base 50 of the flexure 40 has a protruding portion 901 and a recessed portion 903. The protruding portion 901 protrudes from the surface 51 of the metal base 50 toward the surface 31. The protruding portion 901 has a circular shape in plan view, for example.

The surface 51 includes a surface 511 on which the protruding portion 901 is formed and a surface 513 on which the protruding portion 901 is not formed. The surface 511 is substantially parallel to the surface 513, for example. From another perspective, the surface 511 is substantially parallel to the surface 31. The recessed portion 903 is indented from the surface 53 toward the surface 51. The recessed portion 903 overlaps with the protruding portion 901 along the third direction Z.

In this embodiment as well, the fixation portions 91, 93, and 95 each have a gap portion 905 between the surface 31 and the surface 51. The gap portion 905 is defined around the protruding portion 901. In the gap portion 905, the surface 31 and the surface 51 (surface 513) are separated from each other.

In this embodiment, the height H1 of the protruding portion 901 is less than the thickness HM of the metal base 50. The thickness HM of the metal base 50 is an example of the thickness of the flexure 40. The height H1 of the protruding portion 901 in this embodiment is, for example, the distance between the surface 511 and the surface 513 along the third direction.

When focusing on the relationship with the protruding portion 35, the height H1 of the protruding portion 901 is less than the height H2 (shown in FIG. 5) of the protruding portion 35. With this configuration, it is possible to ensure the contact pressure between the protruding portion 35 and the tongue portion 55 of the flexure 40.

The height H1 of the protruding portion 901 should preferably be one-tenth or more of the thickness of the flexure 40. With this configuration, it is possible to precisely create a step in the surface 513 of the flexure 40, and reliably form the gap portion 905.

Further, the fixation portions 91, 93, and 95 further include a welded portion 907 where the load beam 30 and the metal base 50 are welded together. In plan view, the welded portion 907 is smaller in size than the protruding portion 901 and the recessed portion 903. Note that the protruding portion 901 in this embodiment is formed to have a size similar to that of the first embodiment.

According to this embodiment as well, advantageous effects similar to those of the first embodiment can be obtained.

In each of the above-described embodiments, the surface 31 corresponds to the first surface, the surface 33 corresponds to the third surface, the surface 51 corresponds to the second surface, the surface 53 corresponds to the fourth surface, the first end portions 71a and 73a correspond to the first end portions, respectively, the second end portions 71b, 73b correspond to the second end portions, respectively, the protruding portion 901 corresponds to the first protruding portion, the protruding portion 35 corresponds to the second protruding portion, the tongue portion 55 corresponds to the mounting portion where the slider is mounted, and the arms 71 and 73 correspond to a pair of arms.

When implementing the above-described embodiments, the specific configurations of various elements constituting the hard disk drive, including the load beam, flexure and the like, can be modified in various ways.

Various embodiments can be formed by appropriately combining a plurality of components disclosed in the above embodiments. For example, some components may be omitted from the full set of components shown in each embodiment. Further, components from different embodiments may be appropriately combined.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A suspension for a hard disk drive, comprising: a load beam including a first surface;
a flexure including a second surface facing the first surface; and
at least one fixation portion to which the load beam and the flexure are fixed, wherein
the at least one fixation portion comprises:
a first protruding portion protruding from one of the first surface and the second surface toward an other surface, where the first surface and the second surface are brought into contact with each other, and
a gap portion defined around the first protruding portion between the first surface and the second surface, where the first surface and the second surface are separated from each other.

2. The suspension for a hard disk drive, according to claim 1, wherein
the flexure further includes a mounting portion on which a slider is mounted,
the load beam further includes a second protruding portion which overlaps the mounting portion, and protrudes toward the flexure,
the at least one fixation portion is provided on an distal end side relative to the mounting portion, and
a height of the first protruding portion is less than a height of the second protruding portion.

3. The suspension for a hard disk drive, according to claim 1, wherein
the flexure includes a mounting portion on which the slider is mounted, and a pair of arms provided on respective sides of the mounting portion,
the load beam further includes a second protruding portion which overlaps the mounting portion and projects toward the flexure,
the pair of arms respectively include a first end portion located on a distal end side relative to the mounting portion and a second end portion on an opposite side to the first end portion in a longitudinal direction of the flexure,
the at least one fixation portion is provided at the second end portion, and
a height of the first protruding portion is less than a height of the second protruding portion.

4. The suspension for a hard disk drive, according to claim 1, wherein
the at least one fixation portion further includes a welded portion where the load beam and the flexure are welded together, and
a size of the first protruding portion in plan view is greater than a size of the welded portion in plan view.

5. The suspension for a hard disk drive, according to claim 4, wherein
the first protruding portion is located in an area where the load beam and the flexure overlap each other.

6. The suspension for a hard disk drive, according to claim 1, wherein
the first protruding portion has a circular shape in plan view.

7. The suspension for a hard disk drive, according to claim 3, wherein
the first protruding portion protrudes from the first surface toward the second surface.

8. The suspension for a hard disk drive, according to claim 7, wherein
a height of the first protruding portion is less than a thickness of the load beam.

9. The suspension for a hard disk drive, according to claim 7, wherein
the load beam further includes a third surface on an opposite side to the first surface, and
the at least one fixation portion further includes a recessed portion which overlaps the first protruding portion and is recessed from the third surface toward the first surface.

10. The suspension for a hard disk drive, according to claim 3, wherein
the first protruding portion protrudes from the second surface toward the first surface.

11. The suspension for a hard disk drive, according to claim 10, wherein
the height of the first protruding portion is less than the thickness of the flexure.

12. The suspension for a hard disk drive, according to claim 10, wherein
the flexure further includes a fourth surface on an opposite side to the second surface, and
the at least one fixation portion further includes a recessed portion which overlaps the first protruding portion and is recessed from the fourth surface toward the second surface.

13. The suspension for a hard disk drive, according to claim 2, wherein
the flexure includes a mounting portion on which the slider is mounted, and a pair of arms provided on respective sides of the mounting portion,
the load beam further includes a second protruding portion which overlaps the mounting portion and projects toward the flexure,
the pair of arms respectively include a first end portion located on a distal end side relative to the mounting portion and a second end portion on an opposite side to the first end portion in a longitudinal direction of the flexure,
the at least one fixation portion is provided at the second end portion, and
a height of the first protruding portion is less than a height of the second protruding portion.

14. The suspension for a hard disk drive, according to claim 13, wherein
the first protruding portion protrudes from the first surface toward the second surface.

15. The suspension for a hard disk drive, according to claim 14, wherein
the height of the first protruding portion is less than a thickness of the load beam.

16. The suspension for a hard disk drive, according to claim 14, wherein
the load beam further includes a third surface on an opposite side to the first surface, and
the at least one fixation portion further includes a recessed portion which overlaps the first protruding portion and is recessed from the third surface toward the first surface.

17. The suspension for a hard disk drive, according to claim 13, wherein
the first protruding portion protrudes from the second surface toward the first surface.

18. The suspension for a hard disk drive, according to claim 17, wherein
the height of the first protruding portion is less than a thickness of the flexure.

19. The suspension for a hard disk drive, according to claim 17, wherein
the flexure further includes a fourth surface on an opposite side to the second surface, and
the at least one fixation portion further includes a recessed portion which overlaps with the first protruding portion and is recessed from the fourth surface toward the second surface.
